(19) United States
(12) Patent Application Publication
(10) Pub. No.: US 2011/0111321 A1
(43) Pub. Date: May 12, 2011

(54) COMPOSITE PROTON CONDUCTING MEMBRANE WITH LOW DEGRADATION AND MEMBRANE ELECTRODE ASSEMBLY FOR FUEL CELLS

(75) Inventors: Yunsong Yang, Surrey (CA); Jing Li, Surrey (CA); Keping Wang, Richmond (CA)

(73) Assignees: Daimler AG, Stuttgart (DE); Ford Motor Company, Dearborn, MI (US)

(21) Appl. No.: 12/615,671

(22) Filed: Nov. 10, 2009

(51) Int. Cl. H01M 8/10; B05D 5/12

(52) U.S. Cl. 429/483; 427/115

(57) ABSTRACT

A small molecule or polymer additive can be used in preparation of a membrane electrode assembly to improve its durability and performance under low relative humidity in a fuel cell. Specifically, a method of forming a membrane electrode assembly comprising a proton exchange membrane, comprises providing an additive comprising at least two nitrogen atoms to the membrane electrode assembly.

### BACKGROUND

Proton exchange membrane fuel cells (PEMFCs) convert reactants, namely fuel (such as H₂) and oxidant (such as O₂ or air), to generate electric power. PEMFCs generally employ a proton conducting polymer membrane between two electrodes, namely a cathode and an anode. A structure comprising a proton conducting polymer membrane sandwiched between two electrodes is known as a membrane electrode assembly (MEA). MEA durability is one of the most important issues for the development of fuel cell systems in either stationary or transportation applications. For automotive application, an MEA is required to demonstrate durability of about 6,000 hours.

The membrane serves as a separator to prevent mixing of reactant gases and as an electrolyte for transporting protons from anode to cathode. Perfluorosulfonic acid (PFSA) ionomer, e.g., Nafion®, has been the material of choice and the technology standard for membranes. Nafion® consists of a perfluorinated backbone that bears pendent vinyl ether side chains, terminating with SO₃H. The chemical structure of Nafion® is as follows:

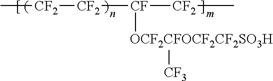

Failure of the membrane as an electrolyte will result in decreased performance due to increased ionic resistance, and failure of the membrane as a separator will result in fuel cell failure due to mixing of anode and cathode reactant gases. The chemical degradation of PFSA membrane during fuel cell operation is proposed to proceed via the attack of hydroxyl (.OH) or peroxyl (.OOH) radical species on weak groups (such as a carboxylic acid group) on the ionomer molecular chain. The free radicals may be generated by the decomposition of hydrogen peroxide with impurities (such as Fe²⁺) in a Fenton type reaction. In fuel cells, hydrogen peroxide can be formed either at Pt supported on carbon black in the catalyst layers or during the oxygen reduction reaction. The formation of hydrogen peroxide, generation of free radical, and degradation of the membrane are depicted in the scheme of FIG. 1.

The hydroxyl radical attacks the polymer unstable end groups to cause chain zipping and/or could also attack an SO₃— group under dry condition to cause polymer chain scission. Both attacks degrade the membrane and eventually lead to membrane cracking, thinning or forming of pinholes. The membrane degradation rate is accelerated significantly with increasing of the operation temperature and decreasing inlet gas relative humidity (RH).

Additive technologies have been applied to reduce membrane degradation in fuel cells. Additives studied included metal chelating agents, antioxidants, free radical scavengers, catalysts for decomposition of hydrogen peroxide, and combinations thereof.

What is needed is an improved additive technology that provides additional resistance of MEAs, and specifically PFSA membranes of the MEAs, to degradation, resulting in improved MEA durability and performance under low RH in a fuel cell.

### SUMMARY

Provided is a small molecule or polymer additive that can be used in preparation of a composite PFSA membrane to improve durability and performance under low RH in a fuel cell. In particular, a water insoluble small molecule or polymer containing at least two nitrogen atoms (e.g., —NH—, —N═, or both —NH— and —N═ groups) can be used in the preparation of composite proton exchange membranes (PEMs).

Specifically, provided is a method of forming a membrane electrode assembly comprising a proton exchange membrane and electrode, the method comprising providing an additive comprising at least two nitrogen atoms to the membrane electrode assembly, where the additive can form a complex with a metal ion. Providing the additive to the membrane electrode assembly can comprise incorporating the additive into the membrane, incorporating the additive into an ionomer of an electrode of the membrane electrode assembly, and/or spray coating the additive on a surface of an electrode of the membrane electrode assembly. It is preferred that the membrane is a perfluorosulfonic acid membrane or a hydrocarbon ionomer membrane.

Further, provided is a proton exchange membrane for a membrane electrode assembly comprising perfluorosulfonic acid and an additive comprising at least two nitrogen atoms. Additionally, provided is a membrane electrode assembly comprising a proton exchange membrane comprising perfluorosulfonic acid and an electrode comprising an additive, wherein the additive comprises at least two nitrogen atoms.

### BRIEF DESCRIPTION OF THE FIGURES OF THE DRAWING

FIG. 1 illustrates a scheme depicting the degradation of a membrane in a fuel cell.

FIG. 2 shows exemplary small molecular additives according to the present disclosure.

FIGS. 3 and 4 shows exemplary polymer additives according to the present disclosure.

FIG. 5 shows a complex of 2,2′-Bipyridine and a metal ion.

FIG. 6 illustrates a scheme of proton dissociation by a complex.

FIG. 7 illustrates a scheme of grafting complex forming units (i.e., ligands) to a polymer for Ru³⁺ capture.

FIG. 8 illustrates an exemplary perfluoro backbone including an additive according to the present disclosure.

FIG. 9 is a graph of fluorine release rates of various membranes.

FIGS. 10 and 11 are graphs of polarization curves of various membranes at 95° C., 95% relative humidity and 30% relative humidity, respectively.

FIG. 12 shows results of open circuit voltage tests and fluorine release rates of various MEAs.

FIG. 13 is an Fourier transform infrared spectroscopy (FTIR) spectra of various membranes.

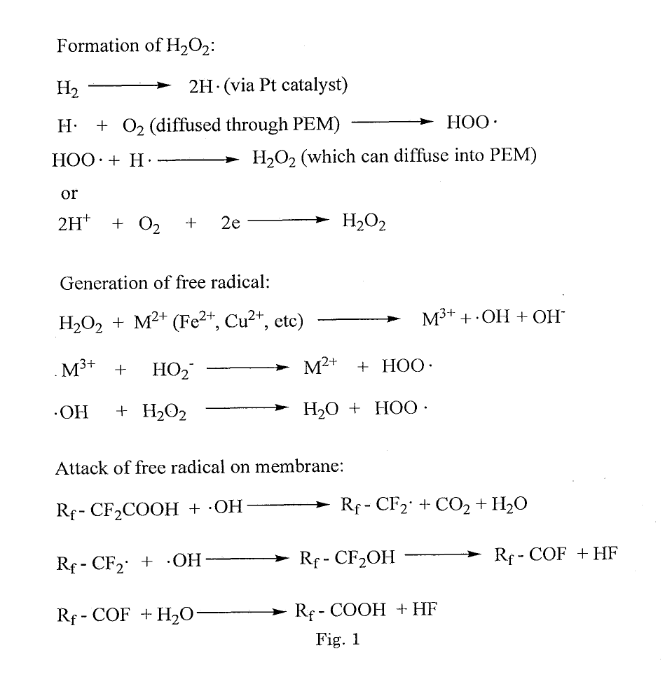

### DETAILED DESCRIPTION

The presently disclosed additives, which can be used in the membrane, an ionomer of an electrode (cathode and/or anode), and/or in a spray coating on gas diffusion electrode (GDE) surfaces, to protect the membrane from hydroxyl radical attack, are selected based on a high reactive rate with hydroxyl radicals, less impact on fuel cell performance than has been observed with most metal oxide radical scavengers, and low water washability.

The additive can be incorporated into the membrane by mixing, for example, a perfluorosulfonic acid ionomer dispersion or a hydrocarbon ionomer solution with an additive to provide an additive and ionomer solution. A membrane is then cast from the mixture solution. In another embodiment, the additive can be dissolved in an ionomer dispersion, and then spray coating the dispersion onto the surface of a GDE. The coated GDE can then be bonded with a proton conducting membrane to make the assembly. In another embodiment, a catalyst is mixed with the ionomer dispersion containing the additive to make an ink, and then spray coating the ink on an electrode to make a GDE.

The presently disclosed additives contain at least two nitrogen atoms for formation of a complex with metal ions. The additive, which can be added into the membrane or ionomer, is a water insoluble organic molecule or a polymer with functional groups which can coordinate with metal ions that exist in the membrane or the metal ions formed during fuel cell operation, rather than being a complex of metal ion or oxide. The additive is soluble in a PFSA ionomer dispersion.

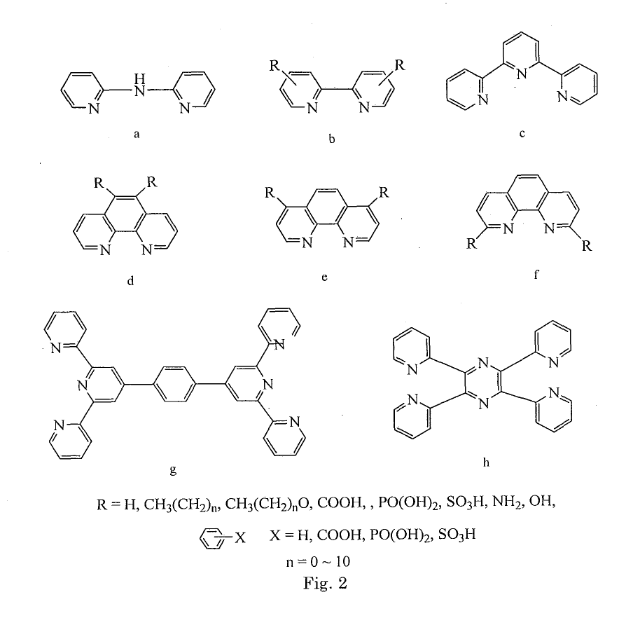

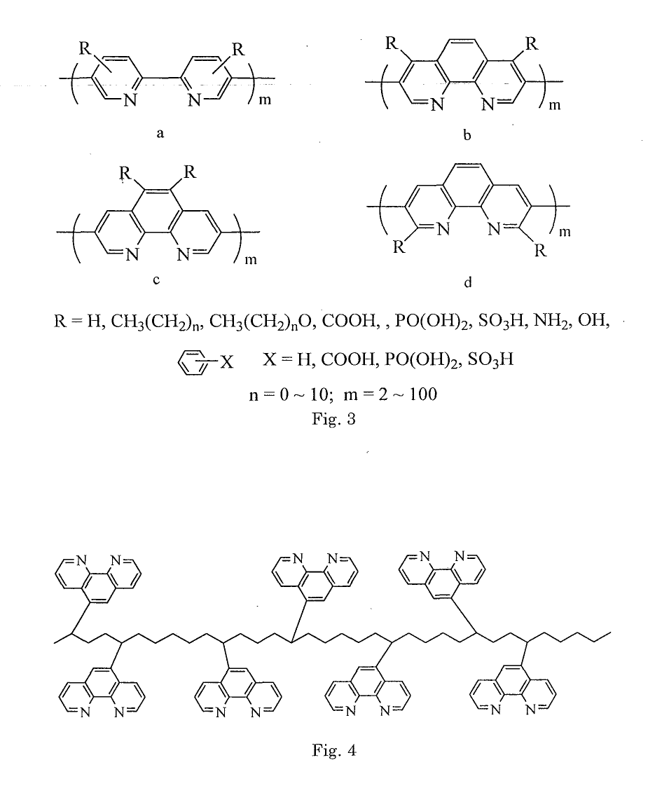

The additive can be a small molecule or polymer which contains units to form a complex with metal ions. As examples, the chemical structure of small molecular additives such as dipyridylamine, dipyridyl, phenanthroline, terpyridine, 4′-4″″-(1,4-phenylene)bis(2,2′:6′,2″-terpyridine, tetra-2-pyridinylpyrazine and their derivatives are shown in FIG. 2. With regard to polymer additives, the complex forming units can be either on the polymer backbone (FIG. 3) or on side chains (FIG. 4). The additives can be homopolymers of complex forming units (FIG. 3) or copolymers of complex forming units with an aromatic structure (such as poly(ether ketone), poly(ether sulfone), poly(phenylene), etc). Copolymers can be random or block copolymers. When a complex forming unit is on the polymer side chain, it can be directly attached to the polymer backbone or attached via a spacer. The polymer backbone can be an aromatic, semi- or perfluoro aliphatic polymer. On each side chain, there can be one complex forming unit or multiple complex forming units. In FIGS. 2 and 3, n=0-10, and in FIG. 3, m=2-100.

When incorporated into a membrane, the additive can be present in an amount of about 0.01 to 10 weight %, for example, from about 0.5 to 2.0 weight %, based on weight of the membrane. When mixed with an ionomer and coated on an electrode, the additive can be present in an amount of about 0.01 to 10 weight %, for example, from about 2 to 5 weight %, based on weight of the ionomer.

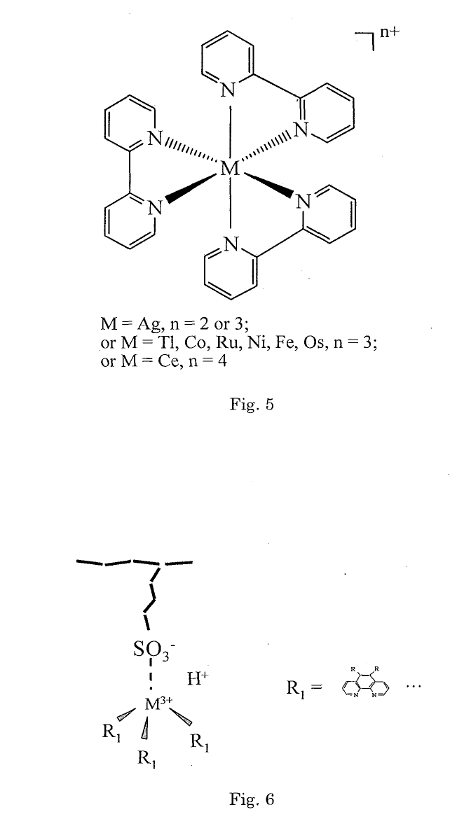

The presently disclosed additives have multiple functions. First, the additives can form complexes with metal ion impurities in the membrane or ionomer. The metal ions could come from, for example, processing of ionomer synthesis and membrane fabrication or from humidity water streams, Gas Diffusion Layer (GDL), or bipolar plates during fuel cell operation. The metal ions react with hydrogen peroxide (produced during fuel cell operation) to generate free radicals to degrade the membrane. After forming a complex with the additive, the metal ions are inactivated. Therefore, less or even no free radicals will be generated. It has been proven that metal ion chelating agents can reduce generation of free radicals in a Fenton like reaction. (See The Journal of Biological Chemistry, 1984, 259(6): 3620-3624). Second, the additive itself is a free radical scavenger, and the formed complex with the metal ion becomes an even better free radical scavenger. For example, the reaction rate of 2,2′-bipyridine with hydroxyl free radical is 6.2×10⁹ L mol⁻¹ s⁻¹ (Int. J. Radiat. Phys. Chem. 1971, 3: 259-272), while the reaction rate of tris(2,2′-bipyridyl) iron(III) ion with hydroxyl free radical (see FIG. 5) is 1.0×10¹⁰ L mol⁻¹ s⁻¹ (J. Chem. Soc., Dalton Trans., 1982, 1953-1957). Third, the complex of a complex forming unit with a metal ion can oxidize hydrogen peroxide to produce H₂O and O₂ in a non-Fenton chemistry (D. H. Macartney, Can J Chem 1986, 64: 1936-1942; I. A. Salem, M El-maazawi, A. B. Zaki, International Journal of Chemical Kinetics, 2000, 32(11): 643-666). Therefore, hydrogen peroxide produced during fuel cell operation is decomposed by the complex without generation of free radicals.

Furthermore, the cobalt, ruthenium and platinum metals or alloys used as anode or cathode catalysts can dissolve into ionomers under an electric field in the acidic environment during fuel cell operation, especially, in start up-shut down process or cell voltage reversal due to fuel starvation. Ruthenium dissolved in anode and crossover to cathode is a serious issue that can cause performance loss due to lowering of Pt surface catalysis activity.

Complex forming units according to the present disclosure can bond to metals, for example, cobalt; ruthenium or platinum, to form coordinate complexes. These complexes are highly active with regard to decomposition of hydrogen peroxide to produce water. These complexes, particularly a complex containing platinum, can also catalyze the reaction of hydrogen with oxygen to produce water. Therefore, the complexes formed in the ionomer layer and membrane can function as catalysts that catalyze hydrogen and oxygen from crossover to produce water in the membrane to make it self-humidifying.

Without wishing to be bound by any theories, it is believed that the complexes can also provide a static electric field force to dissociate protons when there are not enough water molecules (less than three molecules per SO₃— group) in the membrane under dry condition. Therefore, the hydrogen atoms, which bond to an SO₃— group via a hydrogen bond, can be dissociated to be a proton and transport through the membrane to improve the conductivity under dry conditions.

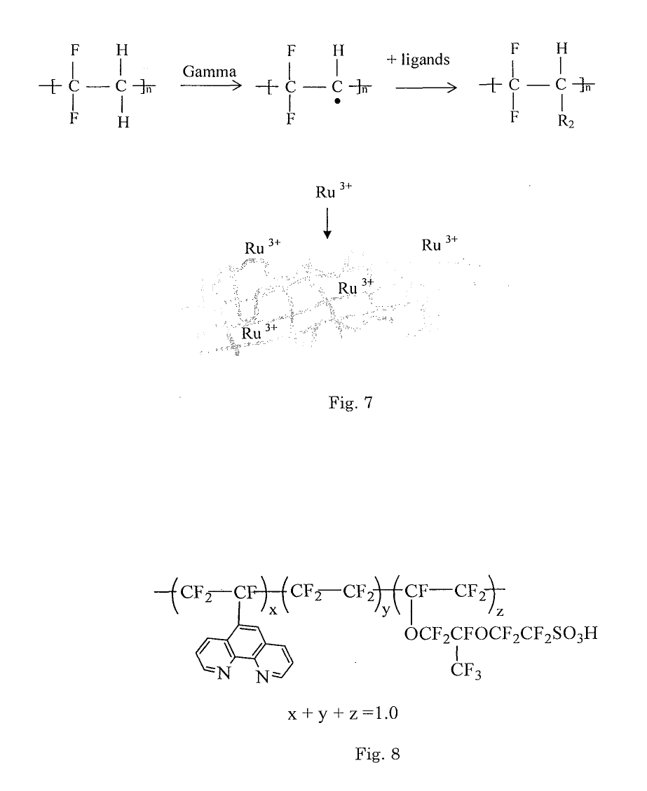

To prevent ruthenium crossover from anode to cathode, the complex forming units can (1) be added into an ionomer with about 2-5 weight % concentration that is coated on an anode catalyst layer surface, (2) chemically bond to a polymer backbone, as shown in FIG. 6, and then be added into a membrane, and/or (3) be grafted onto the surface of porous polymer reinforcement materials, such as, for example, polyvinylidene fluoride (PVDF) nanofiber porous film, as shown in FIG. 7. The grafting of complex forming units onto PVDF can be through radical reaction created by radiation. The PVDF layer with a surface modified by grafting complex forming units is chemically inert and immobile. Ru³⁺ can be trapped via coordinating with the complex forming units (i.e., ligands) within this layer as shown in FIG. 7.

The presently disclosed additives can be used with PFSA or hydrocarbon ionomers in dense proton conducting membranes, as well as together with a PFSA membrane or hydrocarbon ionomer and a porous polymer matrix in a reinforcement proton conducting membrane. In particular, the polymer matrix can comprise the presently disclosed additive. The porous matrix can comprise, for example, PTFE (polytetrafluoroethylene), PVDF (polyvinylidene fluoride), P(VDF-HFP) (poly(vinylidenefluoride-co-hexafluoropropylene)), poly(ethylene), poly(propylene), poly(ethylene-co-propylene), poly(ether sulfone), poly(ether ketone), poly(imide), and/or poly(benzimidazole). Furthermore, the porous polymer matrix can comprise a polymer selected from the group consisting of sulfonated polytetrafluoroethylene, sulfonated polyvinylidene fluoride, sulfonated poly(vinylidenefluoride-co-hexafluoropropylene), sulfonated poly(ethylene), sulfonated poly(propylene), sulfonated poly(ethylene-co-propylene), sulfonated poly(ether ketone), sulfonated poly(ether sulfone), sulfonated poly(imide), sulfonated poly(benzimidazole), and combinations thereof. In another embodiment, the porous polymer matrix can comprise a polymer selected from the group consisting of phosphonated polytetrafluoroethylene, phosphonated polyvinylidene fluoride, phosphonated poly(vinylidenefluoride-co-hexafluoropropylene), phosphonated poly(ethylene), phosphonated poly(propylene), phosphonated poly(ethylene-co-propylene), phosphonated poly(ether ketone), phosphonated poly(ether sulfone), phosphonated poly(imide), phosphonated poly(benzimidazole), and combinations thereof. The porous matrix can be modified to bear one or more functional groups, such as, for example, the above-described complex forming units and/or proton carriers (e.g., sulfonic acid, phosphonic acid, sulfonimide, carboxylic acid, and/or sulfonamide).

When working with a proton conducting membrane, in a preferred embodiment, providing the additive to the membrane electrode assembly comprises dissolving the additive in an ionomer dispersion and mixing the ionomer dispersion comprising the dissolved additive with a catalyst to make an ink. The ink is then coated on the proton conducting membrane. The membrane can be coated with the catalyst either on the cathode side or on the anode side, or on both sides. The additive can be in the catalyst on the cathode side, anode side or both sides.

Additionally, provided is a fuel cell comprising a proton conducting membrane and at least one electrode, wherein the proton conducting membrane and/or the at least one electrode comprises a perfluoro backbone or hydrocarbon ionomer comprising the presently disclosed additive (i.e., comprising at least two nitrogen atoms). A monomer bearing one or more complex forming units can be used to synthesize fluoro or hydrocarbon ionomers for a proton conducting polymer and/or ionomer (e.g., in a catalyst layer of a fuel cell electrode). An exemplary perfluoro backbone including an additive comprising two nitrogen atoms is illustrated in FIG. 8.

The membrane electrode assembly can be fabricated in any conventional manner. It is preferred, however, that the assembly is fabricated by bonding a proton conducting membrane with the cathode, anode, or both electrodes; or by bonding a catalyst coated membrane with a gas diffusion layer.

The following illustrative examples are intended to be non-limiting.

### EXAMPLES

A comparative MEA was formed using a chemical stabilized DuPont™ Nafion® PFSA NRE211 membrane (without additive, hereinafter “NRE211”), bonded with two gas diffusion electrodes. Exemplary MEAs were formed by mixing additives into a PFSA ionomer solution, from which a membrane was cast and bonded with two gas diffusion electrodes. The additives were 5 weight % (of membrane) of the small molecule illustrated as a in FIG. 2 (hereinafter referred to as “A1”); 5 weight % (of membrane) of the small molecule illustrated as b in FIG. 2 (when R═H, hereinafter referred to as “A2”); and 1 weight % (of membrane) of 1-10-phenanthroline (d in FIG. 2 when R═H, hereinafter referred to as “A4 additive”). Membrane chemical degradation rate in an open circuit voltage (OCV) test at 95° C. and 30% RH was characterized by fluorine release rate (FRR) in cathode and/or anode outlet water and OCV lifetime.

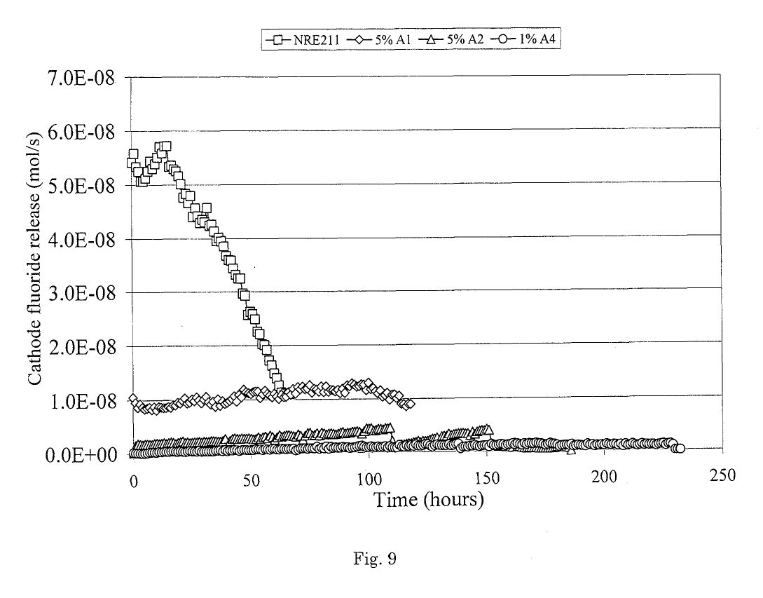

In particular, FIG. 9 shows FRRs of the comparative membrane and three exemplary membranes described above. As shown in FIG. 9, the FRR of each of the three exemplary membranes was lower than that of NRE211. A4 additive was found to be more efficient than A1 additive or A2 additive in reducing membrane chemical degradation, as the membrane with 1 weight % A4 additive had a lower FRR than the membrane with 5 weight % A1 additive or the membrane with 5 weight % A2 additive.

Table 1 provides OCV lifetime results of monolithic membranes with different additives.

TABLE 1

| Membrane | 1 wt. % A4 | 5 wt. % A1 | 5 wt. % A2 | NRE211 |
|---|---|---|---|---|
| OCV lifetime | 230 | 119 | 186 | 66 |
| (hours) | | | | |

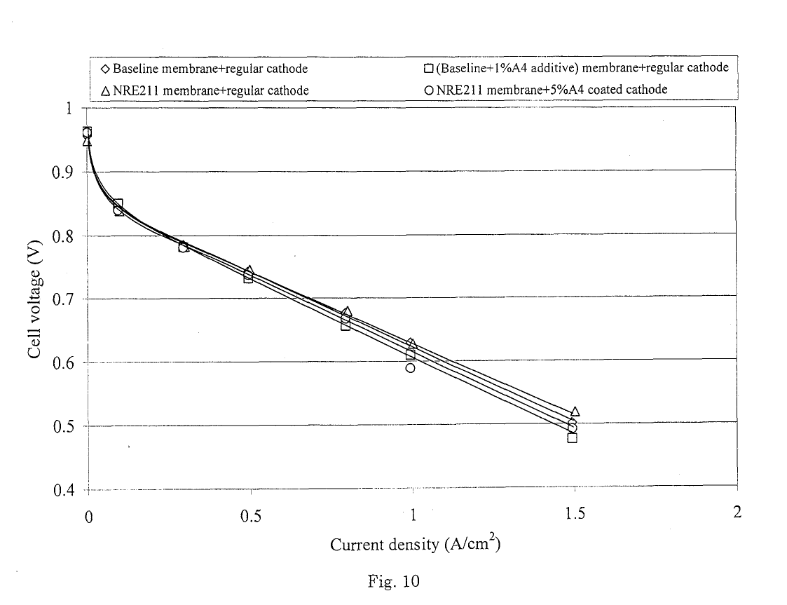

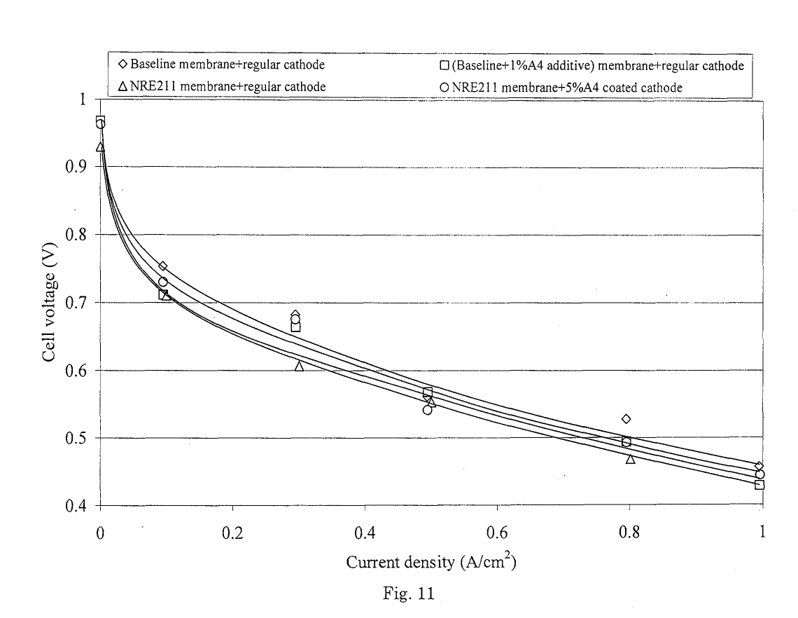

While the OCV lifetime of the 1 wt. % A4 membrane was approximately 4 times longer than that of NRE211, as shown in Table 1, performance of the membrane with A4 additive was only slightly lower than a “Baseline” membrane without additive (due to the strong interaction of additive with SO₃H, resulting in slightly lower conductivity), as shown in FIGS. 10 and 11, which are graphs of polarization curves of various membranes at 95° C., 95% relative humidity and 30% relative humidity, respectively.

In FIGS. 10 and 11, “Baseline” refers to a cast PFSA membrane, while “Baseline ionomer+1 wt. % A4 additive” refers to a “Baseline” cast PFSA membrane with 1 weight % A4 additive. Both membranes were bonded with two GDEs with Pt loading of 0.7 mg/cm² in the cathode and 0.3 mg/cm² in the anode to make MEAs. NRE211 was bonded with the same GDEs to make another comparative MEA, while an MEA with NRE211 bonded to the same anode, but with a cathode that had catalyst with 5 weight % A4 additive in the ionomer coated on a GDL was also formed. In the 5 weight % A4 coated cathode, 5 weight % is the weight percentage of additive to (ionomer+additive). In the process for preparation of the 5 weight % A4 coated cathode, 5 weight % A4 additive was dissolved in an ionomer dispersion, and then the ionomer dispersion containing 5 weight % additive was mixed with catalyst to make ink, which was spray coated on a GDL to make a GDE.

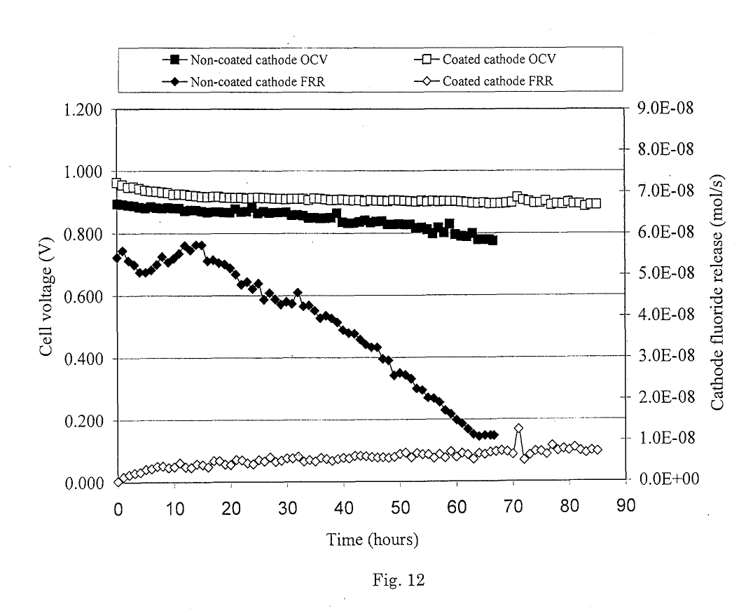

Regarding the effect of A4 additive on performance and stability of catalyst, while an MEA containing NRE211 and a cathode coated with PFSA ionomer containing 5 weight % A4 additive showed only slightly lower performance than the “Baseline” MEA of FIGS. 10 and 11, an MEA with a coated cathode had a much lower FRR than an MEA with a non-coated cathode, as demonstrated in FIG. 12, which shows results of open circuit voltage tests and fluorine release rates of MEAs with NRE211 and a coated or non-coated cathode.

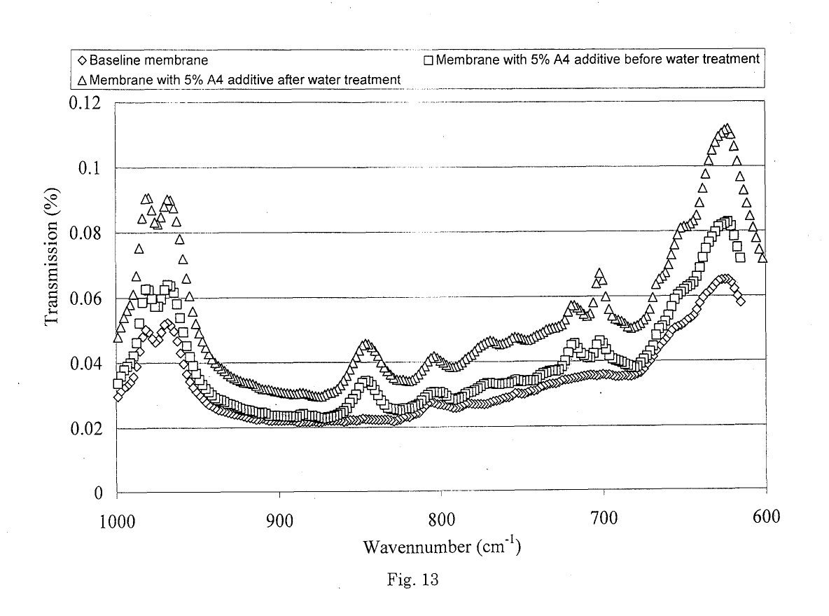

While the additive has strong interactions with PFSA membranes, the additive is water insoluble. As shown in FIG. 13, when a 0.2 g membrane containing 5 weight % A4 additive was soaked in 300 mL water at 80° C. for 70 hours, there was no evidence of additive concentration decrease from infrared (IR) measurement.

Thus, the presently claimed method, proton exchange membrane, and membrane electrode assembly provide for reduced MEA degradation, as evidenced by FRR and OCV lifetime results. The presently disclosed additives efficiently reduce chemical degradation of ionomer in both the membrane and catalyst layer. Consequently, not only is membrane durability increased, but stability of catalyst in the electrode is also increased.

While various embodiments have been described, it is to be understood that variations and modifications may be resorted to as will be apparent to those skilled in the art. Such variations and modifications are to be considered within the purview and scope of the claims appended hereto.

What is claimed is:

1. A method of forming a membrane electrode assembly comprising a proton exchange membrane and electrodes, the method comprising:
providing an additive comprising at least two nitrogen atoms to the membrane electrode assembly, wherein the additive can form a complex with a metal ion.

2. The method of claim 1, wherein providing the additive to the membrane electrode assembly comprises incorporating the additive into the membrane, and the membrane is a perfluorosulfonic acid membrane or a hydrocarbon ionomer membrane.

3. The method of claim 1, wherein providing the additive to the membrane electrode assembly comprises incorporating the additive into an ionomer of an electrode of the membrane electrode assembly.

4. The method of claim 1, wherein providing the additive to the membrane electrode assembly comprises spray coating the additive on a surface of an electrode of the membrane electrode assembly.

5. The method of claim 1, wherein the additive is selected from the group consisting of small molecules, polymers, or combinations thereof.

6. The method of claim 1, wherein the additive is a small molecule selected from the group consisting of: 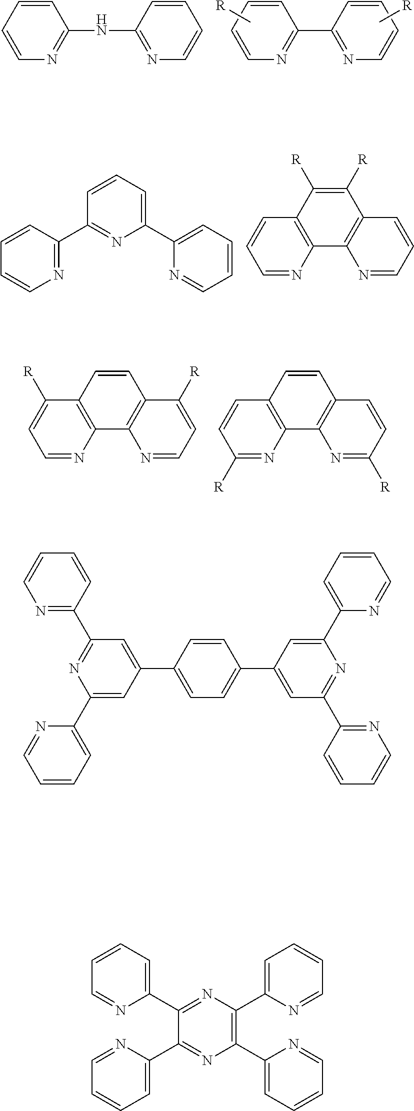
wherein R is selected from the group consisting of H, CH₃(CH₂)ₙ, CH₃(CH₂)ₙO, COOH, PO(OH)₂, SO₃H, NH₂, OH, or 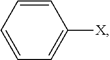
X═H, COOH, PO(OH)₂, SO₃H
and n=0-10.

7. The method of claim 1, wherein the additive is a polymer and the at least two nitrogen atoms are on a backbone of the polymer.

8. The method of claim 7, wherein the additive is selected from the group consisting of: 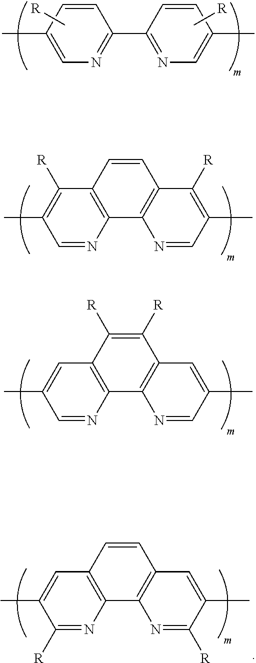
wherein:
m=2-100; and
R is selected from the group consisting of H, CH₃(CH₂)ₙ, CH₃(CH₂)ₙO, COOH, PO(OH)₂, SO₃H, NH₂, OH, or 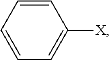
X═H, COOH, PO(OH)₂, SO₃H
and n=0-10.

9. The method of claim 1, wherein the additive is a polymer and the at least two nitrogen atoms are on one or more side chains of the polymer.

10. A membrane electrode assembly formed according to the method of claim 1.

11. A method of protecting a proton exchange membrane of a membrane electrode assembly from hydroxyl radical attack comprising forming a membrane electrode assembly according to the method of claim 1.

12. The method of claim 2, wherein incorporating the additive into the membrane comprises:
mixing a perfluorosulfonic acid ionomer dispersion or hydrocarbon ionomer solution with an additive comprising at least two nitrogen atoms to provide an ionomer and additive mixture solution; and
casting a membrane from the ionomer and additive mixture solution.

13. The method of claim 1, wherein providing the additive to the membrane electrode assembly comprises:
dissolving the additive in an ionomer dispersion;
spray coating the ionomer dispersion comprising dissolved additive on the surface of a GDE, and then bond the coated GDE with a proton conducting membrane to make a membrane electrode assembly.

14. The method of claim 1, wherein providing the additive to the membrane electrode assembly comprises:
dissolving the additive in an ionomer dispersion;
mixing the ionomer dispersion comprising dissolved additive with catalyst to make an ink; and
spray coating the ink as a gas diffusion layer on an electrode to make a GDE, and then bond the GDE with a proton conducting membrane to make a membrane electrode assembly.

15. The method of claim 13 wherein the additive is present in an amount of about 0.01 to 10 weight % of the ionomer.

16. The method of claim 13 wherein the additive is present in an amount of about 2 to 5 weight % of the ionomer.

17. A proton exchange membrane for a membrane electrode assembly comprising:
perfluorosulfonic acid or a hydrocarbon ionomer; and
an additive; wherein the additive comprises at least two nitrogen atoms and can form a complex with a metal ion.

18. The membrane of claim 17, wherein the additive is selected from the group consisting of small molecules, polymers, or combinations thereof.

19. The membrane of claim 17, wherein the additive is present in an amount of about 0.01 to 10 weight % of the membrane.

20. The membrane of claim 17, wherein the additive is present in an amount of about 0.5 to 2.0 weight % of the membrane.

21. A membrane electrode assembly comprising:
a proton exchange membrane comprising perfluorosulfonic acid or a hydrocarbon ionomer; and
an electrode comprising an additive;
wherein the additive comprises at least two nitrogen atoms and can form a complex with a metal ion.

22. The membrane electrode assembly of claim 21, wherein the electrode comprising the additive is selected from the group consisting of a cathode, an anode, or both a cathode and an anode.

23. A reinforcement proton conducting membrane comprising:
a perfluorosulfonic acid or a hydrocarbon ionomer; and
a porous polymer matrix;
wherein the porous polymer matrix comprises an additive comprising at least two nitrogen atoms or chemical units comprising at least two nitrogen atoms.

24. A reinforcement proton conducting membrane comprising:
a perfluorosulfonic acid with an additive or a hydrocarbon ionomer with an additive, and a porous polymer matrix, wherein the additive comprises at least two nitrogen atoms.

25. A reinforcement proton conducting membrane comprising:
a perfluorosulfonic acid with additive or hydrocarbon ionomer with additive; and a porous polymer matrix comprising additive; wherein additive comprises at least two nitrogen atoms.

26. The reinforcement proton conducting membrane of claim 23, wherein the porous polymer matrix comprises a polymer selected from the group consisting of polytetrafluoroethylene, polyvinylidene fluoride, poly(vinylidenefluoride-co-hexafluoropropylene), poly(ethylene), poly(propylene), poly(ethylene-co-propylene), poly(ether sulfone), poly(ether ketone), poly(imide), poly(benzimidazole), and combinations thereof.

27. The reinforcement proton conducting membrane of claim 23, wherein the porous polymer matrix comprises a polymer selected from the group consisting of sulfonated polytetrafluoroethylene, sulfonated polyvinylidene fluoride, sulfonated poly(vinylidenefluoride-co-hexafluoropropylene), sulfonated poly(ethylene), sulfonated poly(propylene), sulfonated poly(ethylene-co-propylene), sulfonated poly(ether ketone), sulfonated poly(ether sulfone), sulfonated poly(imide), sulfonated poly(benzimidazole), and combinations thereof.

28. The reinforcement proton conducting membrane of claim 23, wherein the porous polymer matrix comprises a polymer selected from the group consisting of phosphonated polytetrafluoroethylene, phosphonated polyvinylidene fluoride, phosphonated poly(vinylidenefluoride-co-hexafluoropropylene), phosphonated poly(ethylene), phosphonated poly(propylene), phosphonated poly(ethylene-co-propylene), phosphonated poly(ether ketone), phosphonated poly(ether sulfone), phosphonated poly(imide), phosphonated poly(benzimidazole), and combinations thereof.

29. The membrane electrode assembly of claim 1, wherein the membrane electrode assembly is fabricated by bonding a proton conducting membrane with the cathode and anode electrodes.

30. The membrane electrode assembly of claim 1, wherein the membrane electrode assembly is fabricated by bonding a catalyst coated membrane with a gas diffusion layer.

31. A membrane electrode assembly comprising:
a proton conducting membrane; and
at least one electrode;
wherein the proton conducting membrane or the at least one electrode comprises a perfluoro backbone or hydrocarbon ionomer comprising chemical units to form complex with metal ion, wherein the chemical unit comprises at least two nitrogen atoms.

32. The membrane electrode assembly of claim 31, wherein the membrane electrode assembly is fabricated either by bonding electrodes with proton conducting membrane or by bonding a catalyst coated membrane with a gas diffusion layer.

33. The method of claim 14, wherein the additive is present in an amount of about 0.01 to 10 weight % of the ionomer.

34. The method of claim 14, wherein the additive is present in an amount of about 2 to 5 weight % of the ionomer.

35. The method of claim 24, wherein the porous polymer matrix comprises a polymer selected from the group consisting of polytetrafluoroethylene, polyvinylidene fluoride, poly(vinylidenefluoride-co-hexafluoropropylene), poly(ethylene), poly(propylene), poly(ethylene-co-propylene), poly(ether sulfone), poly(ether ketone), poly(imide), poly(benzimidazole), and combinations thereof.

36. The method of claim 25, wherein the porous polymer matrix comprises a polymer selected from the group consisting of polytetrafluoroethylene, polyvinylidene fluoride, poly(vinylidenefluoride-co-hexafluoropropylene), poly(ethylene), poly(propylene), poly(ethylene-co-propylene), poly(ether sulfone), poly(ether ketone), poly(imide), poly(benzimidazole), and combinations thereof.

37. The method of claim 24, wherein the porous polymer matrix comprises a polymer selected from the group consisting of sulfonated polytetrafluoroethylene, sulfonated polyvinylidene fluoride, sulfonated poly(vinylidenefluoride-co-hexafluoropropylene), sulfonated poly(ethylene), sulfonated poly(propylene), sulfonated poly(ethylene-co-propylene), sulfonated poly(ether ketone), sulfonated poly(ether sulfone), sulfonated poly(imide), sulfonated poly(benzimidazole), and combinations thereof.

38. The method of claim 25, wherein the porous polymer matrix comprises a polymer selected from the group consisting of sulfonated polytetrafluoroethylene, sulfonated polyvinylidene fluoride, sulfonated poly(vinylidenefluoride-co-hexafluoropropylene), sulfonated poly(ethylene), sulfonated poly(propylene), sulfonated poly(ethylene-co-propylene), sulfonated poly(ether ketone), sulfonated poly(ether sulfone), sulfonated poly(imide), sulfonated poly(benzimidazole), and combinations thereof.

39. The method of claim 24, wherein the porous polymer matrix comprises a polymer selected from the group consisting of phosphonated polytetrafluoroethylene, phosphonated polyvinylidene fluoride, phosphonated poly(vinylidenefluoride-co-hexafluoropropylene), phosphonated poly(ethylene), phosphonated poly(propylene), phosphonated poly(ethylene-co-propylene), phosphonated poly(ether ketone), phosphonated poly(ether sulfone), phosphonated poly(imide), phosphonated poly(benzimidazole), and combinations thereof.

40. The method of claim 25, wherein the porous polymer matrix comprises a polymer selected from the group consisting of phosphonated polytetrafluoroethylene, phosphonated polyvinylidene fluoride, phosphonated poly(vinylidenefluoride-co-hexafluoropropylene), phosphonated poly(ethylene), phosphonated poly(propylene), phosphonated poly(ethylene-co-propylene), phosphonated poly(ether ketone), phosphonated poly(ether sulfone), phosphonated poly(imide), phosphonated poly(benzimidazole), and combinations thereof.
